(19) United States
(12) Patent Application Publication
(10) Pub. No.: US 2015/0095031 A1
(43) Pub. Date: Apr. 2, 2015

(54) SYSTEM AND METHOD FOR CROWDSOURCING OF WORD PRONUNCIATION VERIFICATION

(71) Applicant: AT&T Intellectual Property I, L.P., Atlanta, GA (US)

(72) Inventors: Alistair D. CONKIE, Morristown, NJ (US); Ladan GOLIPOUR, Morristown, NJ (US); Taniya MISHRA, New York, NY (US)

(73) Assignee: AT&T Intellectual Property I, L.P., Atlanta, GA (US)

(21) Appl. No.: 14/041,768

(22) Filed: Sep. 30, 2013

(51) Int. Cl. G10L 15/187

(52) U.S. Cl. CPC G10L 15/187
USPC 704/254

(57) ABSTRACT

Disclosed herein are systems, methods, and computer-readable storage media for crowdsourcing verification of word pronunciations. A system performing word pronunciation crowdsourcing identifies spoken words, or word pronunciations in a dictionary of words, for review by a turker. The identified words are assigned to one or more turkers for review. Assigned turkers listen to the word pronunciations, providing feedback on the correctness/incorrectness of the machine made pronunciation. The feedback can then be used to modify the lexicon, or can be stored for use in configuring future lexicons.

### BACKGROUND

1. Technical Field

The present disclosure relates to crowdsourcing of word pronunciation verification and more specifically to assigning words to word pronunciation verifiers (aka turkers) through the Internet or other networks.

2. Introduction

Modern text-to-speech processing relies upon language models running a variety of algorithms to produce pronunciations from text. The various algorithms use rules and parameters, known as a lexicon, to predict and produce pronunciations for unknown words. However, there is no guarantee the words produced from the language models will be accurate. In fact, often lexicons produce words with incorrect or inadequate pronunciations. The only definitive source of information about what constitutes a correct pronunciation is people, and often disagreements can arise regarding pronunciation based on different knowledge and experience with a language, regional preferences, and relative obscurity of a word. In some extreme cases, for example, only an individual having a rare name is confident of the correct pronunciation. To reduce erroneous pronunciations, companies hire word pronunciation verifiers, known as turkers, who will listen to the word pronunciation and provide feedback on it. The companies use the turker feedback to fix specific words and improve the lexicon in general.

### BRIEF DESCRIPTION OF THE DRAWINGS

FIG. 1 illustrates an example system embodiment;

FIG. 2 illustrates an example network configuration;

FIG. 3 illustrates an exemplary flow diagram; and

FIG. 4 illustrates an example method embodiment.

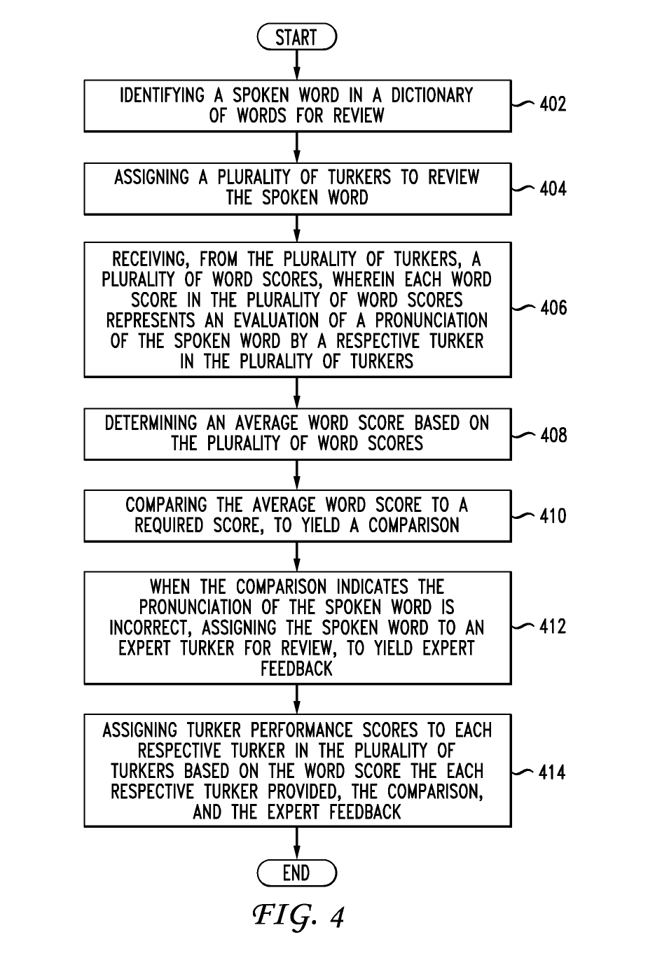

### DETAILED DESCRIPTION

A system, method and computer-readable media are disclosed which crowd source the verification of word pronunciations. Crowdsourcing is often used to distribute work to multiple people over the Internet. Because the individuals are working entirely across networked systems, face-to-face interaction may never occur. A system performing word pronunciation crowdsourcing identifies spoken words, or word pronunciations in a dictionary of words, for review by a turker. A turkers is defined generally as a word pronunciation verifier. An expert turker would be a person who has experience or expertise in the field of pronunciation, and particularly in the field of pronunciation verification. The words identified can be based on user feedback, previous problems with a particular word, or analysis/diagnostics indicating a probability for pronunciation problems. The words identified for review can also be signaled based on social media. For example, if a particular word is trending on social media, the word might be added to the list to ensure the word is being pronounced correctly by the system. After identifying the words which need review, the identified words are assigned to one or more turkers for review. Assigned turkers listen to the word pronunciations, providing feedback on the correctness/incorrectness of the machine made pronunciation. Often, the feedback comes in the form of a word score. The feedback can then be used to modify the lexicon, or can be stored for use in configuring future lexicons.

The system averages the scores of each word and compares the average to a threshold/required score. If the average score indicates the pronunciation of the spoken word is incorrect, the system assigns the spoken word to an expert turker for review. The individual turkers who reviewed the word pronunciation are given a performance score based on how accurately each turker reviewed the machine produced pronunciation.

Consider the following example: a company has an updated version of a text-to-speech lexicon. However, before publically releasing the updated version of the lexicon, the company desires to verify the lexicon works properly by checking problematic word pronunciations against actual humans. A list of the problematic words is created using historical feedback, such as when users report a word being mispronounced or an inability to understand a particular word. Instances where a word or words are repeated multiple times may indicate a pronunciation issue. The list can also come about because previous versions of the lexicon commonly resulted in issues in user comprehension/feedback for particular words. For example, if the previous five changes to the lexicon prompted feedback indicating “hello” was being mispronounced, “hello” should be on the list of words to check prior to releasing the new lexicon.

The list of mispronounced words can also be generated based on specific changes which have occurred to the lexicon, which in turn can affect (for better or worse) specific words. For example, if the lexicon were affected to change the pronunciation of the “ef” sound, the words “efficient” and “Jeff” may both require review. In addition, the list can be automatically generated or manually generated. With automatic generation, the process of assigning words to a list for review can occur via computing devices running algorithms designed to search for various speech abnormalities, such as mismatched phonetics within a period of time. A manually generated list is compiled by a user or users, where the users may or may not be aware of the purpose of the list. For example, when users leave feedback on particular words, those words may be added to the list for subsequent review.

If the turkers indicate a particular word needs additional review, the system can send the word to an expert turker. The expert turker, also known as an expert labeler, reviews the pronunciation and provides a review similar to the reviews of the other “ordinary” turkers. Using the scores, reviews, and feedback from the turkers (both ordinary and expert), the lexicon can be updated. Specifically, the grapheme-to-phoneme model used to convert text to speech can be updated. The update process can occur automatically based on statistical feedback, using the scores and other metrics from the turkers, or can be provided to a lexicon engineer who manually makes the changes to the lexicon.

The turkers, both “ordinary” and “expert,” receive scores based on the word pronunciation review process. The turker scores allow the system to determine which turkers to use for future projects. For example, the turkers can be categorized as “reliable” and “unreliable” based on how the scores of any individual turker compared against the group. Similarly, other categories of categorization can include particular areas of expertise (such as a knowledge of word pronunciations a particular topic, geographic area, ethnicity, language, profession, education, notoriety, and speed of evaluation). These categorizations are not exclusive. For example, a turker may be a reliable, slow turker with an expertise in Hispanic pronunciations of English in Atlanta, Ga. As another example, a turker may be reliable with word pronunciations when given a work deadline of a week, but significantly unreliable when given a work deadline of a day. In yet another example, a turker is an expert at words dealing with cooking, but is very unreliable in words dealing with automobiles. Another turker could be an expert at pop-culture/paparazzi pronunciations.

The turker review process, where turkers receive scores based on how each turker reviews the word pronunciations, can apply to only “ordinary” turkers, only “expert” turkers, or a combination of ordinary and expert turkers. The review process can rank turkers against one another, against a common standard, or against segments of turkers. For example, if a turker specializing in Jamaican pronunciation is being reviewed, the review scores may compare the turker to how other “general” turkers score the same words, how other Jamaican specialists score the words, how an expert turker scores the words, or how often the lexicon is actually modified when the turker reports a poor pronunciation. In another example, expert turkers can be similarly evaluated, where the expert turker is compared to other experts evaluating the same words, against “general” turkers, or in comparison to common standards or a rate of application.

The system can use the review process in assigning available turkers future invitations to review pronunciations. Some projects may require only reliable turkers, whereas other projects can utilize reliable turkers, suspect turkers, and/or untested turkers. The system can also use the review scores given to individual turkers in determining what modifications to make to the lexicon upon receiving the pronunciation scores. For example, if multiple unreliable turkers all indicate a particular word is mispronounced, while a single reliable turker indicates the word is correct, the system can use a formula for determining when the opinion of the multiple unreliable turkers triggers evaluation by an expert despite the single reliable turker indicating the word is being pronounced correctly. The formula can rely on weights associated with the reliability of the individual turkers and the pronunciation scores each turker gave to the pronunciation. Such the weighting can be linear or non-linear, and can be further tied to additional factors associated with the individual turkers, such as an area of expertise or an area of diagnosed weakness.

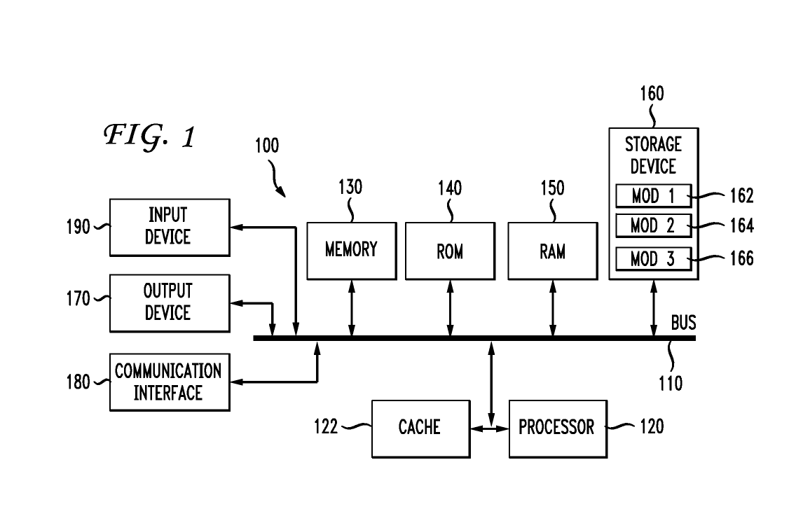

A brief introductory description of a basic general purpose system or computing device in FIG. 1 which can be employed to practice the concepts, methods, and techniques disclosed is illustrated. A more detailed description of crowdsourcing speech verification will then follow with exemplary variations. These variations shall be described herein as the various embodiments are set forth. The disclosure now turns to FIG. 1.

With reference to FIG. 1, an exemplary system and/or computing device 100 includes a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the processor. The processor 120 may be a self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. The system 100 can include other hardware or software modules. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out a particular function. In another aspect, the system can use a processor and computer-readable storage medium to store instructions which, when executed by the processor, cause the processor to perform a method or other specific actions. The basic components and appropriate variations can be modified depending on the type of device, such as whether the device 100 is a small, handheld computing device, a desktop computer, or a computer server.

Although the exemplary embodiment(s) described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

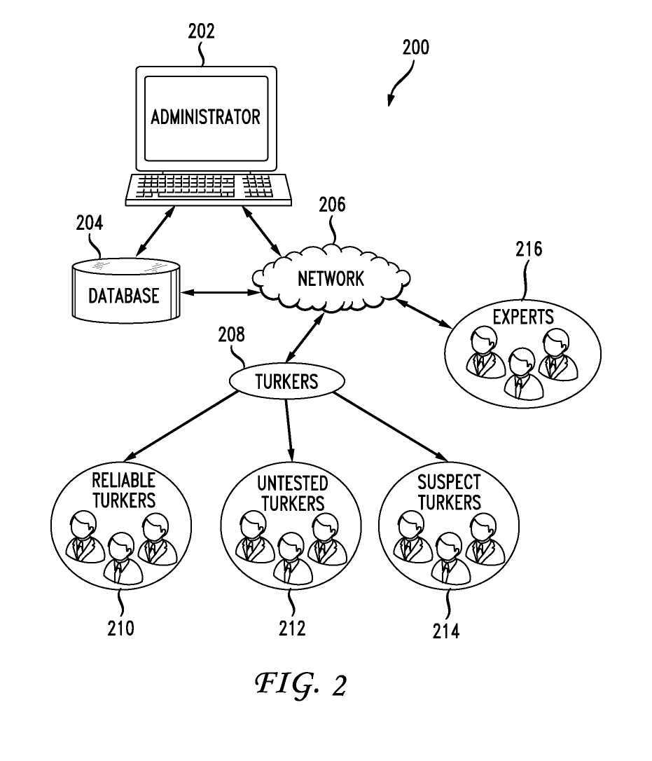

Having disclosed some components of a computing system, the disclosure now turns to FIG. 2, which illustrates an example network configuration 200. An administrator 202 is connected to “ordinary” turkers 208 and expert turkers 216 through a network, such as the Internet or an Intranet. The turkers 208, as illustrated, are subdivided into three groups: reliable turkers 210, untested turkers 212, and suspect turkers 214. Additional divisions of turkers, such as turkers which specialize in languages, regional accents, have fast review times, or are currently unavailable are also possible, with overlap occurring between groups. The turkers 208 may or may not be aware of which group 210, 212, 214 or groups they are assigned to.

The database 204 represents a data repository. Examples of data which can be stored in the database 204 include the lexicon, word pronunciations which need to be reviewed, word pronunciations which have been reviewed, word pronunciation review assignments which need to be made, outstanding assignments, previous assignments, feedback for a currently deployed lexicon, feedback associated with previous lexicons, turker reliability scores, turker availability, turker categories, and future assignments which need to be made. Other data necessary for operation of the system, and effectively making turker assignments, receiving scores and feedback on the word pronunciations, and iteratively updating the lexicon based on the feedback can also be stored on the database 204.

As the administrator 202 assigns turkers 208, 204 to review a list of spoken words, the administrator 202 and the turkers 208, 204 can access the data in the database 204 through the network 206. The administrator 202 making the assignments can be a human being, or the administrator 202 can be an automated computer program. Both manual and automated administrators can use the historical data associated with words, lexicons, feedback, and turker reviews in determining which turkers to assign to projects, or even to specific groups of words. For example, the administrator 202 can determine a project is appropriate for untested turkers 212 based on the number of outstanding projects, the number of words to review, and how often the words being reviewed have been previously reviewed.

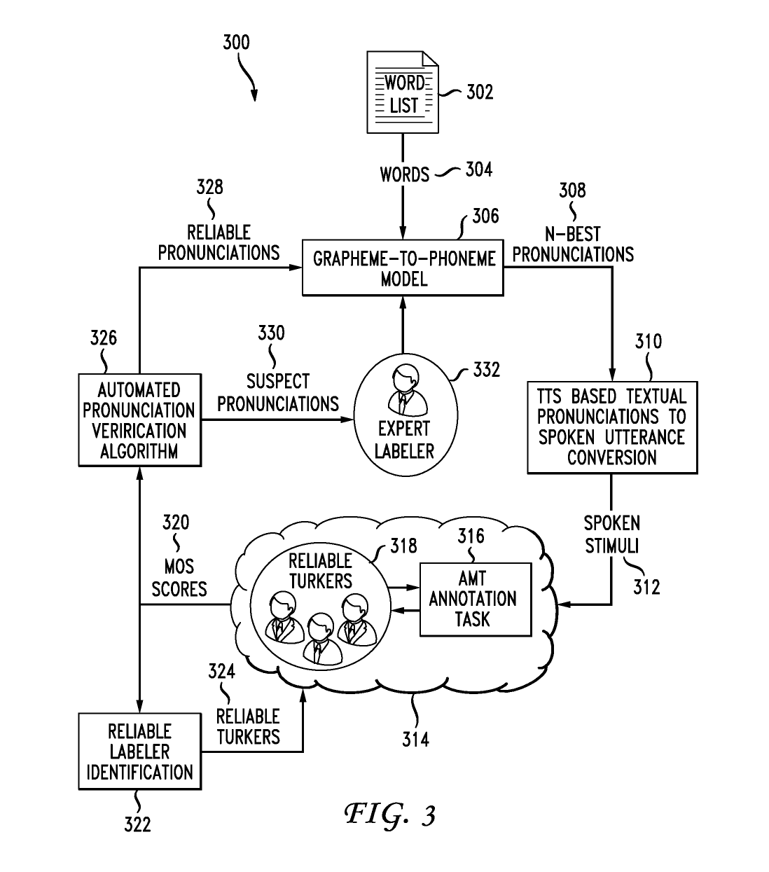

FIG. 3 illustrates an exemplary flow diagram for a system as disclosed herein. A word list 302 is generated. The word list 302 can be automatically generated, using algorithms which analyze words to determine which words have a likelihood above a threshold of being incorrectly pronounced. Automatic generation can also be based on previous incorrect pronunciations, words flagged by a previous group of turkers (for example, “general” turkers identify words as incorrect, and a list of words then goes to an expert turker for review), and/or based on specific modifications made to the lexicon which flag words or classes of words for review. Automatic generation can further encompass monitoring Internet website for trending words, either on social media, such as Twitter® or Facebook®, or on news website or blogs. For example, if a word is used in a certain number of articles from major newspapers in a given week, it may be added to the list of word pronunciations to review. From a “master” list 302, a specific words 304 are converted to speech using a grapheme-to-phoneme model 306. The specific words 304 can be the entire list 302 of words, or only a portion of the list 302.

The grapheme-to-phoneme model 306 converts the words to pronounced words by converting the graphemes associated with each word into phonemes, then combining the phonemes to produce text-to-speech based textual pronunciations. Exemplary graphemes can include alphabetic letters, typographic ligatures, glyph characters (such as Chinese or Japanese characters), numerical digits, punctuation marks, and other symbols of writing systems. Having converted the graphemes to phonemes and produced a text-to-speech based textual pronunciation, the n-best pronunciations 308 are selected. In certain instances, the remaining pronunciations may be identified as not meeting a minimum threshold quality needed prior to turker review. The n-best pronunciations 308 can be selected automatically using similar techniques to the techniques used to select the word list 302 and/or using algorithms which identify word pronunciations best matching recordings, acoustic models, or phonetic rules of sound. Alternatively, the n-best pronunciations 308 can be manually compiled.

After selecting the n-best pronunciations 308, the n-best pronunciations 308 (which are text-to-speech based textual pronunciations) are given additional processing to place them in condition for a spoken utterance. The additional processing, known as spoken utterance conversion 310, polishes the text-to-speech based textual pronunciations by aliasing phonetic junctions between selected phonemes, attempting to more closely match human speech. The result of the additional processing 310 on the n-best pronunciations 308 is spoken stimuli 312 which are distributed through a network cloud 314 to reliable turkers 318 who score the spoken stimuli 312. The turkers 318 can work in conjunction with a mechanical turker 316, such as Amazon's Mechanical Turk (AMT), which annotates the spoken stimuli 312 as the turkers 318 review the spoken stimuli 312. Alternatively, the annotation task 316 can proceed iteratively based on specific input (such as scoring, review, or other feedback) from the turkers 318.

As the reliable turkers 318 review the spoken stimuli 312, the turkers 318 produce MOS scores 320 for the pronunciations reflecting the accuracy and/or correctness of the pronunciations. The MOS scores 320 are further used identify reliable labelers 322, meaning those turkers which produce good results. Reliable turkers 324 can be given, by the system or by human performance reviewers, a higher ranking for future assignments, whereas when turkers produce poor results they can become disfavored for future assignments. The MOS scores 320 are also used by an automated pronunciation verification algorithm, which evaluates the scores 320 based on how the words are being pronounced. If suspect pronunciations 330 exist, the suspect pronunciations are given to an expert labeler 332, who again reviews the words and provides feedback to the grapheme-to-phoneme model 306 for future use in producing word pronunciations and for future versions of the lexicon and/or grapheme-to-phoneme model. Pronunciations deemed reliable 328 by the automated pronunciation verification algorithm 326 are also feed into the grapheme-to-phoneme model.

The various illustrated components of FIG. 3 may be combined differently in various configurations. In the various configurations, the illustrated steps may be added to, combined, removed, or otherwise reconfigured as disclosed herein. For example, in various configurations, the automated pronunciation algorithm 326 can be deployed before submitting the spoken stimuli 312 to the reliable turkers 318. In other configurations, assignments can be made to multiple categories of turkers beyond only reliable turkers 318.

Having disclosed some basic system components and concepts, the disclosure now turns to the exemplary method embodiment shown in FIG. 5. For the sake of clarity, the method is described in terms of an exemplary system 100 as shown in FIG. 1 configured to practice the method. The steps outlined herein are exemplary and can be implemented in any combination thereof, including combinations that exclude, add, or modify certain steps.

The system 100 identifies a spoken word in a dictionary of words for review (402). The word can be identified because of past pronunciations problems, because of an increase in social media use, or because of feedback indicating the word is being mispronounced. The system 100 assigns a plurality of turkers to review the spoken word (404). Turkers can be individuals remotely connected to the system 100 via a network such as the Internet, where the individuals are performing word pronunciation verification. Assignments can be based on particular categories the turkers belong to, such as expertise in a particular accent corresponding to the spoken word, or can be selected based on previous turker evaluations. In addition, the turkers can be selected based on availability of the turkers and/or a deadline associated with the assignment. In some configurations, rather than assigning a plurality of turkers, a single turker can be assigned based on specific circumstances.

From the plurality of turkers, the system 100 receives a plurality of word scores, where each word score in the plurality of word scores represents an evaluation of a pronunciation of the spoken word by a respective turker in the plurality of turkers (406). Scores can take the form of a number, letter, or other form of quantitative feedback which can be measured and compared. Based on the plurality of word scores, the system determines an average word score (408). The average word score is compared to a required score (410). For example, there may be a threshold score the average word score must meet, otherwise the word pronunciation is considered “suspect.” The threshold can vary based on factors such as frequency of word use within the dictionary, complexity of the pronunciation, and experience and/or feedback of the reviewing turkers. If certain turkers have a reputation for grading word pronunciations low, the “suspect” threshold can be lowered to compensate for the turkers.

When the comparison of the word score to the required score (410) indicates the pronunciation of the spoken word is incorrect, assigning the spoken word to an expert turker for review (412). The expert turker, like “general” turkers, can be specialized in specific areas or categories. Alternatively, the expert turker can be a turker having a relatively higher reliability score, or a relatively longer record of turking compared to other turkers. The system 100 records the feedback and/or scores of the turkers and saves the information for future updates to the dictionary of words, for modifying a lexicon used to form the pronunciations, and/or for future updates. The system 100 also assigns turker performance scores to each respective turker in the plurality of turkers based on the word score each respective turker provided, the comparison, and the expert feedback (414). In certain configurations, the turker performance score can be based solely on the word score, solely on the comparison, or solely on the expert feedback, or any combination thereof. The turker performance scores can be saved in a database for later use in making future turker assignments. For example, if a turker consistently scores pronunciations differently than all of the other turkers, the turker can be listed as “suspect” or “unreliable,” and used with less frequency when assignments are made. In addition, the system 100 can modify a grapheme-to-phoneme pronunciation model used to generate the dictionary of words based on the average score, the comparison, and the expert feedback, or any combination thereof.

Companies employing turkers through crowdsourcing as disclosed herein can also base wages, assignment types, bonuses, and frequency of assignments based on the turker performance scores. Over time, consistently high performance scores can result in a “general” turker being upgraded to an “expert” turker, whereas a pattern of low performance scores can result in the turker being downgraded to “suspect” or withdrawn from the pool of turkers altogether. Because the assignments, evaluations, and scores all occur by crowdsourcing over the Internet, it is entirely possible the turkers are unaware of which classification of turker they are assigned to. Turkers can be similarly unaware of classification changes which occur based on performance scores. Accordingly, the system 100 can, after assigning the turker performance scores, assign additional turkers to review a second spoken word, where the additional turkers are assigned based on the turker performance scores.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various configurations described above are provided by way of illustration only and should not be construed to limit the scope of the disclosure. For example, the principles herein apply to crowdsourcing the verification of word pronunciations, and can be applied to preformed pronunciations as well as to pronunciations occurring in real-time. Various modifications and changes may be made to the principles described herein without following the example embodiments and applications illustrated and described herein, and without departing from the spirit and scope of the disclosure. Claim language reciting “at least one of” or “one of” a set indicates that one member of the set or multiple members of the set satisfy the claim.

1. A method comprising:
identifying a spoken word in a dictionary of words for review;
assigning a plurality of turkers to review the spoken word;
receiving, from the plurality of turkers, a plurality of word scores, wherein each word score in the plurality of word scores represents an evaluation of a pronunciation of the spoken word by a respective turker in the plurality of turkers;
determining an average word score based on the plurality of word scores;
comparing the average word score to a required score, to yield a comparison; and
when the comparison indicates the pronunciation of the spoken word is incorrect:
assigning the spoken word to an expert turker for review, to yield expert feedback; and
assigning turker performance scores to each respective turker in the plurality of turkers based on the word score the each respective turker provided, the comparison, and the expert feedback.

2. The method of claim 1, further comprising, after assigning the turker performance scores, assigning additional turkers to review a second spoken word, wherein the assigning of the additional turkers is based on the turker performance scores.

3. The method of claim 2, further comprising modifying a grapheme-to-phoneme pronunciation model used to generate the dictionary of words based on the average score, the comparison, and the expert feedback.

4. The method of claim 1, wherein the plurality of turkers have an expertise in one of an accent and a subject matter.

5. The method of claim 1, wherein the dictionary of words is generated using a grapheme-to-phoneme model.

6. The method of claim 5, further comprising modifying the grapheme-to-phoneme model based on the average word score.

7. The method of claim 1, wherein the average word score is calculated using the plurality of word scores and a weight associated with a reliability of each respective turker in the plurality of turkers.

8. A system, comprising:
a processor; and
a computer-readable storage medium having instructions stored which, when executed by the processor, cause the processor to perform operations comprising:
identifying a spoken word in a dictionary of words for review;
assigning a plurality of turkers to review the spoken word;
receiving, from the plurality of turkers, a plurality of word scores, wherein each word score in the plurality of word scores represents an evaluation of a pronunciation of the spoken word by a respective turker in the plurality of turkers;
determining an average word score based on the plurality of word scores;
comparing the average word score to a required score, to yield a comparison;
when the comparison indicates the pronunciation of the spoken word is incorrect:
assigning the spoken word to an expert turker for review, to yield expert feedback; and
assigning turker performance scores to each respective turker in the plurality of turkers based on the word score the each respective turker provided, the comparison, and the expert feedback.

9. The system of claim 8, the computer-readable storage medium having additional instructions which result in the operations further comprising, after assigning the turker performance scores, assigning additional turkers to review a second spoken word, wherein the assigning of the additional turkers is based on the turker performance scores.

10. The system of claim 9, the computer-readable storage medium having additional instructions which result in the operations further comprising modifying a grapheme-to-phoneme pronunciation model used to generate the dictionary of words based on the average score, the comparison, and the expert feedback.

11. The system of claim 8, wherein the plurality of turkers have an expertise in one of an accent and a subject matter.

12. The system of claim 8, wherein the dictionary of words is generated using a grapheme-to-phoneme model.

13. The system of claim 12, the computer-readable storage medium having additional instructions stored which result in the operations further comprising modifying the grapheme-to-phoneme model based on the average word score.

14. The system of claim 8, wherein the average word score is calculated using the plurality of word scores and a weight associated with a reliability of each respective turker in the plurality of turkers.

15. A computer-readable storage device having instructions stored which, when executed by the processor, cause a computing device to perform operations comprising:
identifying a spoken word in a dictionary of words for review;
assigning a plurality of turkers to review the spoken word;
receiving, from the plurality of turkers, a plurality of word scores, wherein each word score in the plurality of word scores represents an evaluation of a pronunciation of the spoken word by a respective turker in the plurality of turkers;
determining an average word score based on the plurality of word scores;
comparing the average word score to a required score, to yield a comparison;
when the comparison indicates the pronunciation of the spoken word is incorrect:
assigning the spoken word to an expert turker for review, to yield expert feedback; and
assigning turker performance scores to each respective turker in the plurality of turkers based on the word score the each respective turker provided, the comparison, and the expert feedback.

16. The computer-readable storage device of claim 15, the computer-readable storage device having additional instructions which result in the operations further comprising, after assigning the turker performance scores, assigning additional turkers to review a second spoken word, wherein the assigning of the additional turkers is based on the turker performance scores.

17. The computer-readable storage device of claim 16, the computer-readable storage device having additional instructions which result in the operations further comprising modifying a grapheme-to-phoneme pronunciation model used to generate the dictionary of words based on the average score, the comparison, and the expert feedback.

18. The computer-readable storage device of claim 15, wherein the plurality of turkers have an expertise in one of an accent and a subject matter.

19. The computer-readable storage device of claim 15, wherein the dictionary of words is generated using a grapheme-to-phoneme model.

20. The computer-readable storage device of claim 19, the computer-readable storage medium having additional instructions stored which result in the operations further comprising modifying the grapheme-to-phoneme model based on the average word score.
